(19) United States
(12) Patent Application Publication
(10) Pub. No.: US 2019/0171841 A1
(43) Pub. Date: Jun. 6, 2019

(54) METHOD AND SYSTEM FOR ENCRYPTING FILES AND STORING THE ENCRYPTED FILES IN A STORAGE FILE SYSTEM

(71) Applicant: SCRAM SOFTWARE PTY LTD, Melbourne, Victoria VIC (AU)

(72) Inventors: Ron STEINFELD, Melbourne, Victoria VIC (AU); Linus CHANG, Melbourne, Victoria VIC (AU); Conrad JAKOB, Melbourne, Victoria VIC (AU)

(21) Appl. No.: 16/320,805

(22) PCT Filed: Jul. 27, 2017
(86) PCT No.: PCT/IB2017/054562

§ 371 Date: Jan. 25, 2019

(30) Foreign Application Priority Data
Jul. 27, 2016 (GB) 1613015.5

(51) Int. Cl. G06F 21/62; H04L 9/06; G06F 16/13

(52) U.S. Cl. CPC G06F 21/6227; G06F 16/13; H04L 9/0618; G06F 21/629

(57) ABSTRACT

A method, system and a computer program product for encrypting files and storing the encrypted files in a storage file system. A software encryption layer is configured to be located between a caller application and the storage file system. Unencrypted file names and file content are exposed by the software encryption layer to the caller application. The software encryption layer encrypts, authenticates and stores file names, file modification and creation timestamps, and file contents obtained from the caller application and controls file access by allocating different encryption keys to at least one of different groups of files or different portions of file contents.

### TECHNICAL FIELD

The aspects of the disclosed embodiments relate generally to data storage methods and systems; and more specifically, to methods and systems for encrypting files and storing the encrypted files in a storage file system.

### BACKGROUND

Typically, a user stores data on storage devices such as computer's hard drives, removable hard drives, memory cards, universal serial bus (USB) devices or on remote storage devices such as cloud storage systems. The data generally includes sensitive information such as credit card details, personal information, and work product related information which needs to be protected from an attacker's unauthorized access to the data.

The data may get compromised either in privacy or in integrity as secure access to these storage devices cannot be guaranteed at all times. For example, the attacker can read the data stored in the USB device without knowledge of the user when the attacker gains an access to the USB drive even for a small duration. Similarly, the attacker can modify the data stored in the memory card, and the user may not be able to detect such modification. Further, a relatively large number of users prefer to use the cloud storage system for storing data. As a result, a cloud operator has a relatively increased liability to ensure that the data in the cloud storage system is not compromised. However, an unauthorized access to the data via a malicious attack (whether by a human or a computer program) raises a challenge for the cloud operator to protect the data stored therein.

Generally, data is encrypted while storing in the storage devices in order to maintain privacy and integrity of the data. In a general art, an entire hard disk or a partition of the hard disk is encrypted. When the user desires to access the data stored in the encrypted hard disk or partition, firstly decryption is performed using a key and subsequently, the user is provided access to the desired data.

In a US Patent Publication No. 20120179915, a system and a method of authenticating a user logging into an operating system stored on an encrypted drive is disclosed. Further, this patent publication discloses that the system accesses the operating system on the encrypted drive based on the credentials and starts the operating system. However, the system fails to protect files stored in the cloud storage system, as it lacks integrity checking for detecting unauthorized modifications (e.g., tampering) to the data. Further, the system can-not operate at granular level (e.g., at a file level) as the system is designed to operate at the drive level. Furthermore, the system will be inefficient and inoperable in a cloud environment because it is impractical to upload the hard drive to the cloud storage system every time a user makes a change to some data.

In a U.S. Pat. No. 6,249,866, a system and method for encryption and decryption of files is disclosed. When the user puts a file in an encrypted directory or encrypts a file, the file is encrypted with a file encryption key generated from a random number, and in turn the file encryption key is encrypted with both a public key of the user and the public key of at least one recovery agent to form the encrypted key information. The encrypted key information is stored with the file, whereby the user or a recovery agent can decrypt the file data using the private key thereof. When a proper private key is used, encrypted data is decrypted transparently by the file system and returned to the user. However, this prior art solution requires a two-step encryption process involving both symmetric and public-key cryptography. As a result, every time the user desires to share the file with an additional user on the storage system, this prior art solution requires modification of encryption related information of the file as the encryption key needs to be encrypted with the additional user's public key. Consequently, the existing prior art solution requires additional computational and storage operations and correspondingly becomes slow.

### SUMMARY

In an embodiment, a method of encrypting files and storing the encrypted files in a storage file system, the method comprises:
configuring a software encryption layer to be located between a caller application and the storage file system;
exposing unencrypted file names and file content by the software encryption layer to the caller application;
encrypting, authenticating and storing by the software encryption layer file names, file modification and creation timestamps, and file contents obtained from the caller application; and
controlling file access by the software encryption layer by allocating different encryption keys to at least one of different groups of files or different portions of file contents, wherein the controlling comprises using a master encryption key to derive subordinate encryption keys, and sharing and distributing the subordinate encryption keys to allow selective access to predetermined subsets of files, or portions of file contents of the storage file system.

Furthermore, in an embodiment, a system of encrypting files and storing the encrypted files in a storage file system, the system comprises:
a software encryption layer configured to be located between a caller application and the storage file system;
wherein the software encryption layer is adapted to expose unencrypted file names and file content to the caller application;
wherein the software encryption layer is adapted to encrypt, authenticate and store file names, file modification and creation timestamps, and file contents obtained from the caller application; and
wherein the software encryption layer is adapted to control file access by allocating different encryption keys to at least one of different groups of files or different portions of file contents, wherein the software encryption layer is adapted to control file access by using a master encryption key to derive subordinate encryption keys, and share and distribute the subordinate encryption keys to allow selective access to predetermined subsets of files, or portions of file contents of the storage file system.

Accordingly, the aspects of the disclosed embodiments ensure transparent encryption and decryption of the files or different portions of file contents to protect privacy with the storage file system and thereby, efficiently secures files on the storage file system. An association of access levels with the encryption keys to control the access of the files or different portions of file contents enables the user to share the files with other users by merely distributing the encryption keys. Further, the present invention enables use of multiple keys for a single file and thereby, reduce the impact of a key being compromised. Furthermore, the present invention enables parallel processing of the encryption and decryption of data on multi-core and multi-processor computing devices and thereby reduces the time taken to access the data.

The storage file system can be a cloud storage system. As a result, the user can share the files or different portions of the file contents with other users on the cloud storage system. Moreover, the present invention protects data in-transit and allows the user to hold possession of the encryption keys in the cloud storage system.

Furthermore, according to a first embodiment, controlling file access by the software encryption layer may include using a master encryption key to derive subordinate encryption keys and sharing and distributing the subordinate encryption keys to allow selective access to predetermined subsets of files of the storage file system. Thereby, the software encryption layer is adapted to control access to the predetermined subsets of files or different portions of file contents. Further, controlling file access by the software encryption layer may include deriving a dedicated set of encryption keys for each directory of the storage file system. Thereby the software encryption layer is adapted to control access to the directories or sub-directories of the storage file system.

According to a second embodiment, controlling the access by the software encryption layer may include deriving different types of encryption keys for different levels of access to names of files and directories. The different levels of access may comprise no access, listing pathnames of a single directory, and listing pathnames of an entire directory and its children. Thereby, the software encryption layer is adapted to identify directory level encryption keys to authenticate user's access to the pathnames in a specific directory.

Additionally, the different levels of access to file contents may comprise no access, access to parts of a single file, access to the whole of a single file, access to all files of a single directory, and access to all files of a directory and all its child directories. Thereby, the software encryption layer is adapted to identify file level encryption keys to authenticate user's access to content of a specific file.

According to a third embodiment, the software encryption layer may be adapted to perform the encrypting by using a symmetric encryption scheme. Thereby, the efficiency of the encryption and decryption of the files or file contents substantially increases when compared with asymmetric encryption. Further, the software encryption layer is adapted to utilise symmetric encryption algorithms that are resistant to an attack from at least one quantum computing device. As a result, the system becomes relatively more efficient than systems which employ asymmetric encryption.

According to a fourth embodiment, the encrypting process may include splitting the file content into blocks and encrypting each block separately, and wherein the controlling may comprise calculating a block authentication tag for each block independently and storing the block authentication tag at a predetermined location of the file. Further, the controlling may comprise calculating an additional authentication tag over all block authentication tags, the file name and file header authentication tags, to ensure integrity of the file contents, file name and file creation and modification times. Thereby, the software encryption layer is adapted to provide fast random access to files or file contents with integrity checking.

Implementation of the proposed encryption of files and storing the encrypted files in the storage file system may be based at least in part on a computer program comprising code means for producing the above method steps which run on a computer device. The computer program may be stored on a computer readable medium or may be downloadable from a private or public network.

Further advantageous modifications are defined in the dependent claims.

### BRIEF DESCRIPTION OF THE DRAWINGS

The summary above, as well as the following detailed description of illustrative embodiments, is better understood when read in conjunction with the appended drawings. For the purpose of illustrating the aspects of the disclosed embodiments, exemplary constructions are shown in the drawings. However, the aspects of the disclosed embodiments are not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a schematic block diagram of an environment wherein a system of encrypting files and storing the encrypted files in a storage file system can be implemented;

FIGS. 2A-B illustrate an example hierarchy level of directories and corresponding encryption keys for controlling access to the directories and files of the storage file system;

FIGS. 3A-C illustrate a table disclosing encryption keys required to distribute in order to gain access to a directory, subtree, and file contents; and

FIGS. 4A-C illustrate an embodiment of the layout of information within an encrypted file.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF THE EMBODIMENT

In the following, exemplary embodiments will be described based on a cloud storage and data sharing application that will synchronize and share files in a user's local computer to the cloud storage while applying transparent encryption and integrity checking in accordance with the aspects of the disclosed embodiments. However, it will be apparent from the following description and is therefore explicitly stressed that the aspects of the disclosed embodiments can be applied to any other application that requires data to be saved and accessed in a secure format. The aspects of the disclosed embodiments can facilitate provisioning of an application programming interface to a third party application developer so that the third party application developer can utilize the functional aspects of the present invention to develop additional applications for sectors such as military, banking, medical, e-commerce and the other sectors which require secure access to the data at different hierarchy levels.

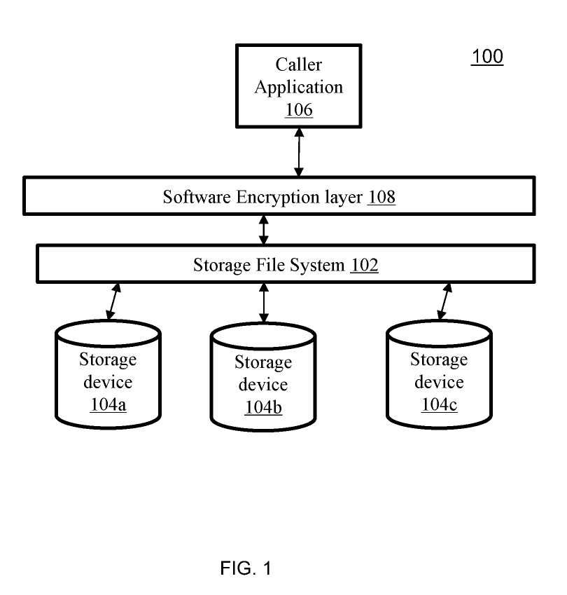

FIG. 1 illustrates a schematic block diagram of an environment 100 wherein a system of encrypting files and storing the encrypted files in a storage file system 102 can be implemented. The storage file system 102 is configured to logically organize data as a hierarchical structure of directories or files stored in one or more storage devices such as a storage device 104a, a storage device 104b and a storage device 104c (collectively referred herein to as the storage device 104). The storage device 104 can include a physical storage device such as a local hard drive, a networked hard drive, a removable disk drive, a memory card, a universal serial bus (USB) drive, a virtual drive and other storage devices adapted to store data. Further, each file has a corresponding file name and refers to one or more physical or logical locations within the storage device 104 to store file content. The file content can be available in various formats such as a text format, an audio format, an image format, a video format, a multimedia file format or in any other proprietary or non-proprietary file format. Further, the directories may refer to a special file including information related to other files or directories. Thus data available on the storage device 104 includes file names and corresponding file contents, other system files including information regarding directories.

Additionally, a user accesses one or more files stored in the storage device 104 via a caller application 106. The caller application 106 can be any cloud based software application such as a cloud storage and data sharing application, a backend transaction application for an e-commerce platform configured to store transactional or operational data on the cloud storage, or any other cloud based software application which facilitates authenticated access to the data stored on the storage device 104. The caller application 106 is configured to include application programming interfaces which can be used by other cloud based applications to gain access to the storage device 104 via the storage file system 102. Alternatively, the caller application 106 can be a desktop application which provides access to the storage device 104 only on authentication of the user.

As illustrated in FIG. 1, a software encryption layer 108 is configured to be located between the storage file system 102 and the caller application 106. The software encryption layer 108 is adapted to expose unencrypted file names and file content to the caller application 106. Further, the software encryption layer 108 is adapted to encrypt, authenticate and store file names, file modification and creation timestamps, and file contents obtained from the caller application 106. Furthermore, the software encryption layer 108 is adapted to control file access by allocating different encryption keys to at least one of different groups of files or different portions of file contents stored in the storage device 104.

Thus the software encryption layer 108 ensures that the caller application 106 has unencrypted access to file names and content depending on the authorization level of the user when the caller application 106 is adapted to access the file names and content. In addition, when the caller application 106 is required to store data in the storage device 104 during an operation, the software encryption layer 108 acts as an intermediate layer between the caller application 106 and the storage file system 102 and further, the software encryption layer 108 encrypts as well as assigns authentication information corresponding to the data generated from the caller application 106. Subsequently, the encrypted data is stored in form of files in the storage device 104.

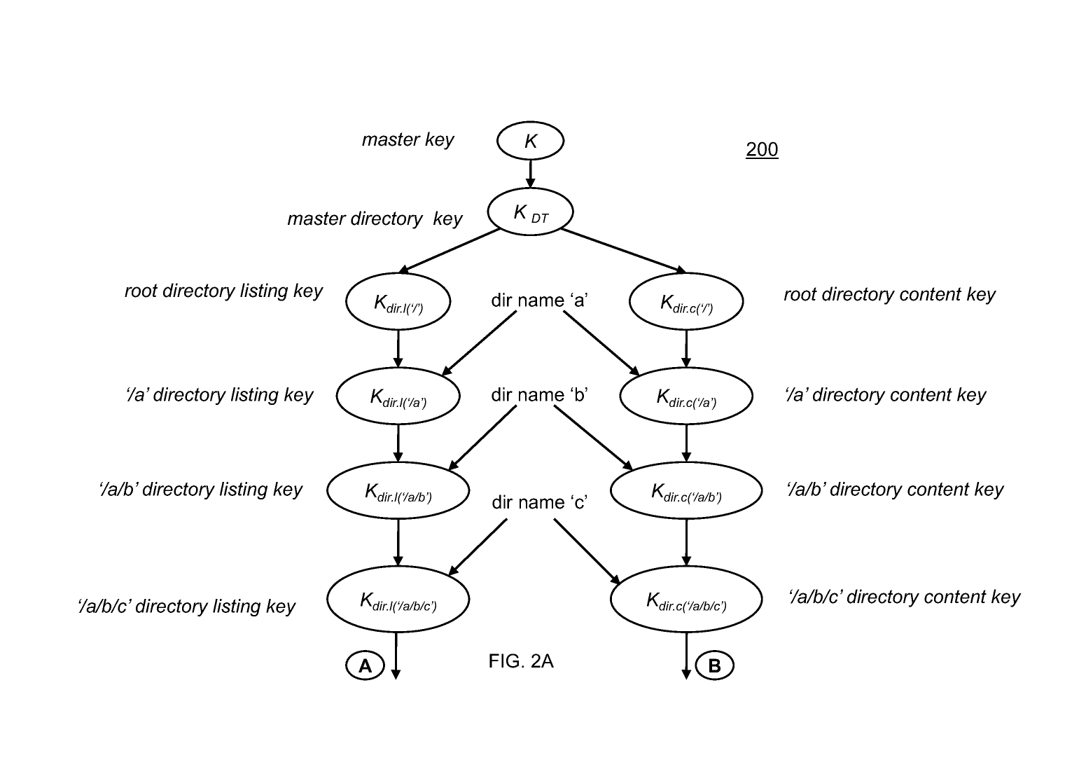

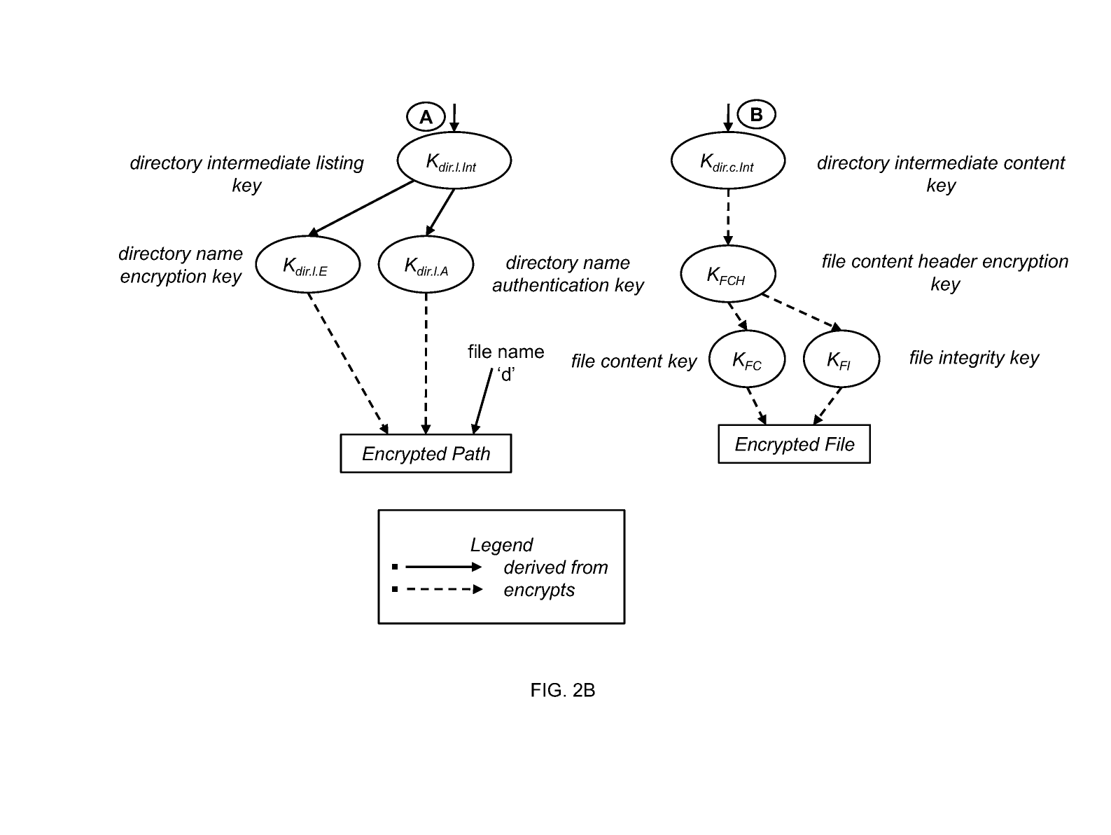

Further, the system of the encrypting files and storing the encrypted files in the storage file system 102 ensures seamless encryption key management which will be discussed in FIG. 2. The encryption key management ensures transparent encryption and decryption of the data and thereby, enables protection of privacy of the data in a simple and efficient manner. In another instance, this method ensures a transparent integrity checking to determine whether the data has been modified by the attacker.

FIG. 2 illustrates an example hierarchy level of directories and corresponding encryption keys for controlling access to the directories and files of the storage file system 102, in accordance with an embodiment of the present invention.

According to a first embodiment, the software encryption layer 108 is adapted to use a master key to derive subordinate encryption keys which unlock the storage file system 102. Further the software encryption layer 108 is adapted to share and distribute subordinated encryption keys to allow selective access to predetermined subsets of files, or different portions of file contents of the storage file system 102. In addition, the subordinated encryption keys are derived from the master encryption key.

As shown in FIG. 2, a master encryption key K can be used by the software encryption layer 108 to derive subordinate encryption keys for system 102. The software encryption layer 108 is adapted to control the access to the entire storage file system 102 using the master encryption key K. As shown in the hierarchy level 200, a master directory key KDT is shown which is derived from the master encryption key K and hence subordinate to the master encryption key K. The master directory key KDT can be used by the software encryption layer 108 to derive subordinate encryption keys to decrypt a specific master directory and the contents thereof. Based on the access category corresponding to the encryption keys, the software encryption layer 108 is adapted to control the access to the one or more directories.

Further, the software encryption layer 108 is adapted to allocate a dedicated set of encryption keys to each directory of the storage file system 102. As illustrated in FIG. 2, the master directory “I” has subordinate directories such as a directory “/a”, a directory “/a/b”, a directory “/a/b/c” and a filename“/a/b/c/d”. The software encryption layer 108 is adapted to allocate the dedicated set of encryption keys to each of these directories. The dedicated set of encryption keys can include a directory listing key, a directory intermediate listing key, a directory content key, and a directory intermediate content key. As discussed above, each of the dedicated set of the encryption keys is derived from the master encryption key K.

Further, the software encryption layer 108 is adapted to allocate different types of encryption keys to different levels of access. In particular, the different types of encryption keys provide selective access to the predetermined subsets of files, or different portions of file contents of the storage file system.

According to a second embodiment, the different levels of access at a directory level can include no access to the directory, a single directory access, and a single directory plus subtree access. A subtree access can be referred to an access to one or more sub-directories of the single directory. The sub-directories can include children directories, grandchildren directories, great grandchildren directories and the like. Additionally, the different levels of access at a file level can include no access to the file, single file access, access to different portions of single file, access to all files of a single directory, and access to all files of a directory and all its child directories.

In other words, the user will get access to a specific directory or its contents thereof only when the user is in possession of encryption key(s) corresponding to the respective access level. The user will not be able to access a specific file within the directory if the access level of the encryption key of the user for the specific directory or its contents does not match with the access level required to access the specific directory or its contents.

With reference to FIGS. 2A-B, the user will get access to a particular directory “/a/b” when the user's encryption key corresponds to an access level required to access the particular directory “/a/b”. The encryption key corresponding to the single directory access enables the user to access only the single directory. Such a type of encryption key may not enable the user to access the contents of another sub-directory “/a/b/c” or file“/a/b/c/d”. Similarly, the user will get access to the single directory plus child directory access when the user's encryption key corresponds to the single directory plus child directory access.

Thus the present invention enables the software encryption layer 108 to allow granular level cryptographic access control and sharing of the files and the corresponding contents stored on the storage device 104. The software encryption layer 108 can be adapted to allow selective access to specific subsets of the storage file system 102 using the encryption keys. In other words, the software encryption layer 108 is adapted to control access of the storage file system 102 through encryption. Depending on the access level of the encryption keys, the user can gain access to the contents of the storage file system 102.

Further, the software encryption layer 108 is adapted to encrypt file names within a directory of the storage file system 102 using a deterministic authenticated encryption algorithm. The deterministic authenticated encryption algorithm is adapted to use the directory intermediate listing key to generate a unique authenticated and encrypted filename for each filename in the directory. The filename is padded to a fixed length before encryption to hide an original filename length. To handle filenames longer than allowed by the storage file system 102, the encrypted filename is truncated and the truncated remainder of the file name is stored in the encrypted file header. The deterministic encryption algorithm enables the software encryption layer 108 to efficiently compute the unique encrypted filename corresponding to a given unencrypted filename from the directory intermediate listing key, without reading or decrypting any filenames from the storage file system 102. The deterministic encryption algorithm also allows to reduce a length overhead of authenticated encrypted file names versus a length of the original filename. The authentication on the encrypted filename serves to protect the integrity of the filename against modification in the storage file system 102.

Furthermore, in a specific cloud storage system, the user can share the entire file system through distribution of the master encryption key K. Further, users having access rights to a particular root directory can share access through distribution of the master directory key KDT. As an example and not as a limitation, if the user might require to share a directory “/a/b” to another user, the encryption keys of the directory “b” are shared with the another user so that the other user can access the directory “/a/b” using the shared encryption keys. Therefore, the present invention enables the user to share the contents on the storage device 104 with other users by sharing the encryption keys. Once the other user receives the required encryption key, the other user can gain access to the content.

Further, the user can control the level of access within the storage device 104 for the other user by sharing the different encryption keys. For example, the user may store his medical data on the cloud storage. The medical data can include data related to his eyes, heart and bones. The user may invoke the caller application 106 to store the medical data on the storage device 104 in a following hierarchy of directories.

<root> /

/ medical /

/ eye
/ heart
/ bones

The user desires to share the contents of a directory “medical”, a sub-directory “eye”, a sub-directory “heart”, and a sub-directory “bones” with a general practitioner, an eye surgeon, a heart surgeon and an orthopaedic surgeon respectively. Accordingly, the user shares encryption keys of the respective directories to the general practitioner, the eye surgeon, the heart surgeon and the orthopaedic surgeon.

The software encryption layer 108 of the present invention is adapted to control access to the data using the encryption keys which control the access level of the directories and contents thereof.

The key derivation system of the aspects of the disclosed embodiments makes it possible to share encrypted data at a granular level by distributing keys in an efficient manner. For example, one of the beneficial aspects of the key derivation system disclosed herewith is that it does not require writing or reading metadata files. Another beneficial aspect of the key derivation system is that it does not require the generation of one or more user public-private key pairs. The key derivation system of the aspects of the disclosed embodiments allows targeted sharing of a subset of a file system or subsets of a file since it allows selective access at different levels. Furthermore, a file, or, one or more subsets of a files can be shared between users by sharing the appropriate key, allowing other portions of the file to remain inaccessible. In turn, sharing the appropriate key corresponding to a subset of a file, for example, prevents a user, from shifting or changing contents within a file and thus keeping the file contents in the context in which it was generated.

The level of security level provided by the key derivation system disclosed herewith is independent of the amount of data encrypted by the system. Since an immensely large number of subordinate keys can be derived from the master key, the level of security of the system is not compromised as more data is added because each key is used for relatively small amounts of data. In this context, one can define ‘relatively large amount of data’ as the amount of data which is large enough to decrease the security level of the system, or in other words, when a key is over-used with respect to the amount of data in which it encrypts. A relatively small amount of data is therefore any amount of data small enough so that a key is not over-used. Thus, the key derivation system disclosed herewith has a property of scalability since it can be scaled for use with any amount of data in a file or in a file system without compromising the level of protection.

The aspects of the disclosed embodiments enable the user to provide restrictive access to other users through distribution of the encryption keys. The user shares the directory listing key and the directory content key of the directory “medical” with the general practitioner so that the general practitioner can have access to the directory “medical”, its sub-directories and the contents thereof. The user shares the directory listing key and the directory content key of the directory “eye” with the eye surgeon so that the eye surgeon can have access to the directory “eye”, its sub-directories (if any) and the contents thereof.

Similarly, the user shares the directory listing key and the directory content key of the directory “heart” with the heart surgeon so that the heart surgeon can have access to the directory “heart”, its sub-directories (if any) and the contents thereof. Further, the user shares the directory listing key and the directory content key of the directory “bones” with the orthopaedic surgeon so that the orthopaedic surgeon can have access to the directory “bones”, its sub-directories (if any) and the contents thereof. Thus distribution of the directory listing key and directory content key will ensure full access to the directory and recursively its child directories.

Further, if the user desires to share access to the directory without sharing an access to the child directories, the user distributes the directory intermediate listing key and directory intermediate content key. Thus in view of the foregoing discussion, if the user does not want to share sub-directories with the general practitioner, the user distributes the directory intermediate listing key and directory intermediate content key of the directory “medical” with the general practitioner.

Furthermore, if the user desires to share directory listing ability without providing access to any files therein, the user distributes the directory listing key for access to the directory and recursive access to its sub-directories. Alternatively, the user distributes the directory intermediate listing key if the user desires to share access to the directory listing.

The user distributes the directory intermediate content key if the user desires to share ability to read/write existing files within a directory without providing access to the directory listing. In addition, if the user desires to share the ability to read/write a specific file, the user distributes the file content header encryption key to the other user. Optionally, in such arrangements, each file is provided with a unique “file content header encryption key”, which is stored in file header encrypted and authenticated in a manner depending on the file name and path. Furthermore, such an arrangement prevents the switching of filenames among different files, as the encryption of the unique “file content header encryption key” in each file is based on the file name and path directory. Therefore, it is impossible for the attacker to swap the names of different files, because the system will be unable to decrypt the “file content header encryption key” stored in the header of the renamed file.

Furthermore, the hierarchy level of directories and corresponding encryption keys for controlling access to the directories and files of the storage file system 102 limits the volume of data encrypted by each key. In other words, the key derivation system provides a different “directory name encryption key” to each directory of the storage file system. Therefore, each directory gets a different encryption key, and the amount of data encrypted by a specific directory name encryption key is restricted to just the file names and subdirectory names in that particular files directory. As a result, the amount of data encrypted using a same key is limited and thereby, the impact of a key being compromised is reduced.

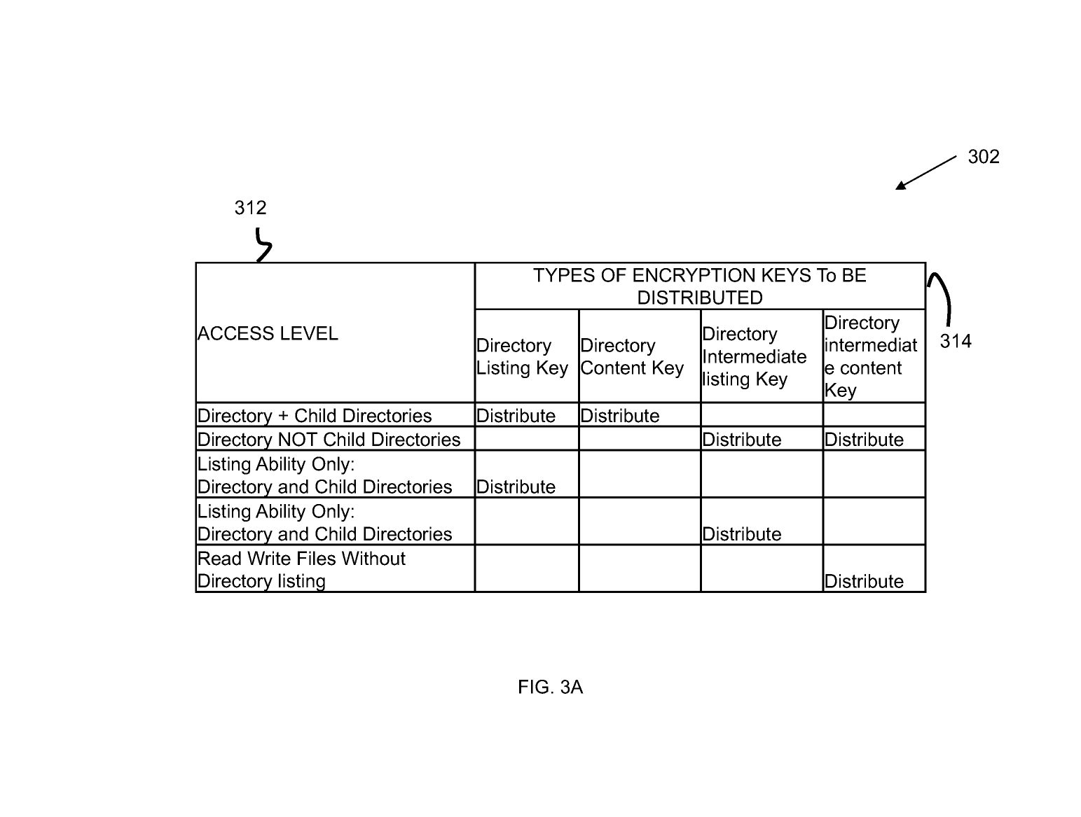

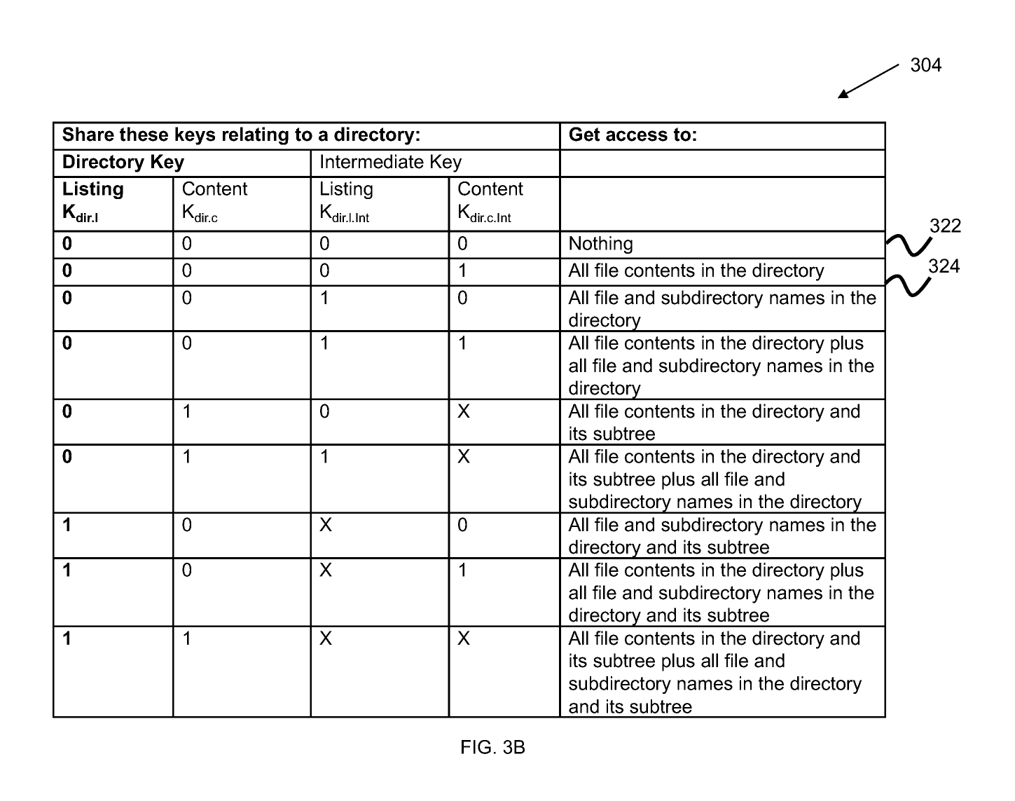

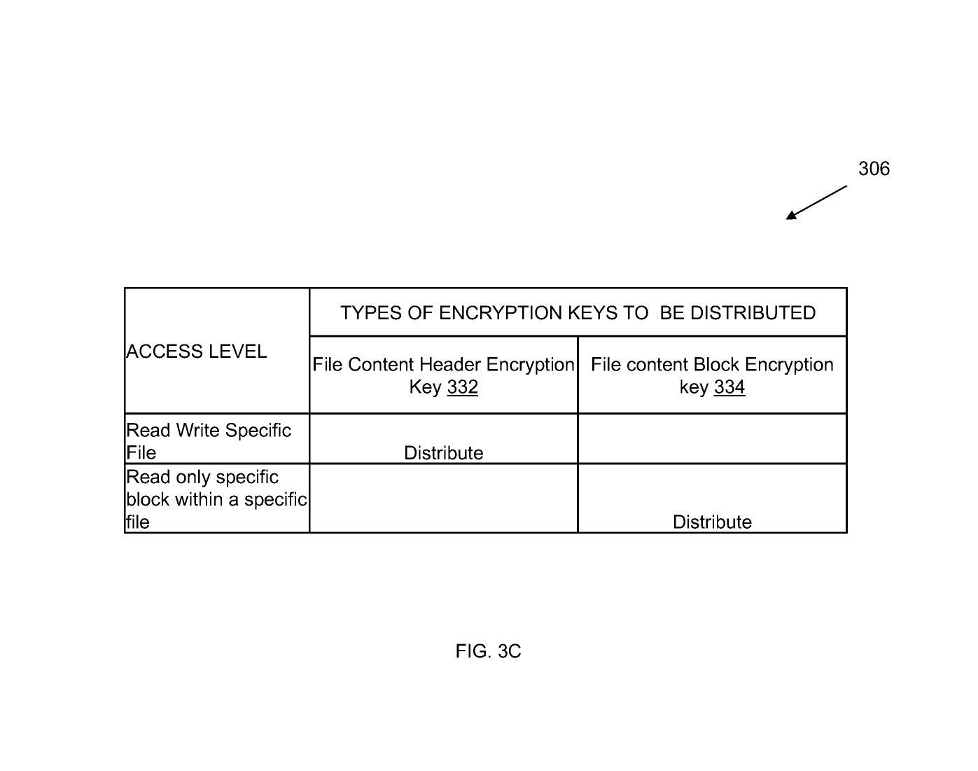

FIGS. 3A-C illustrate a table 302, a table 304 and a table 306 disclosing encryption keys required to gain access to a directory and child directories; file and directory names and file contents within a directory and its subtree; and file contents in a specific file respectively. As indicated in the table 302, the user can distribute different encryption keys to share access at the directory, and the sub-directory. Specifically, a column 312 lists the various access levels for which the software encryption layer 108 can provide support to the user. A row 314 lists the types of encryption keys which are required to attain the access level as listed in the column 312.

FIG. 3B illustrates different level of access available at the directory level when the respective encryption keys are shared with other users. As shown in the table 304, the aspects of the disclosed embodiments enable access control using distribution of the encryption keys. The dedicated set of encryption keys can include a directory listing key K_{dir.l}, a directory intermediate listing key K_{dir.l.Int}, a directory content key K_{dir.c}, and a directory intermediate content key K_{dir.c.Int}. The access to a specific directory depends on the availability of a key corresponding to the specific directory. For example, a row 322 indicates that the other user will not have access to the directory or the contents thereof when the encryption key is available to the user. Similarly, other rows of the table 302 depict the access level provided to the user depending on the availability of the respective keys.

Referring to FIG. 3C, the table 306 illustrates file content encryption keys such as a file content header encryption key 332 and a file content block encryption key 334 are required to gain access at a file level. As indicated in the table 306, the user can distribute the file content header encryption key 322 to provide access to the other user to the entire file, whereas the user can distribute the file content block encryption key 324 to provide access to the other user to specific blocks within the file.

According to a third embodiment, the software encryption layer 108 is adapted to perform the encrypting by using a symmetric encryption scheme. Further, the software encryption layer 108 is adapted to utilize symmetric encryption algorithms which are resistant to an attack from one or more quantum computing devices. Consequently, the system of encrypting files and storing the encrypted files becomes an efficient system. Furthermore, the key derivation system provides limitation on the volume of data encrypted by a single key. As a result, the amount of data encrypted using a single key is limited and this thereby increases the difficulty for an attacker to discover any individual key, and reduces the impact if a key is compromised.

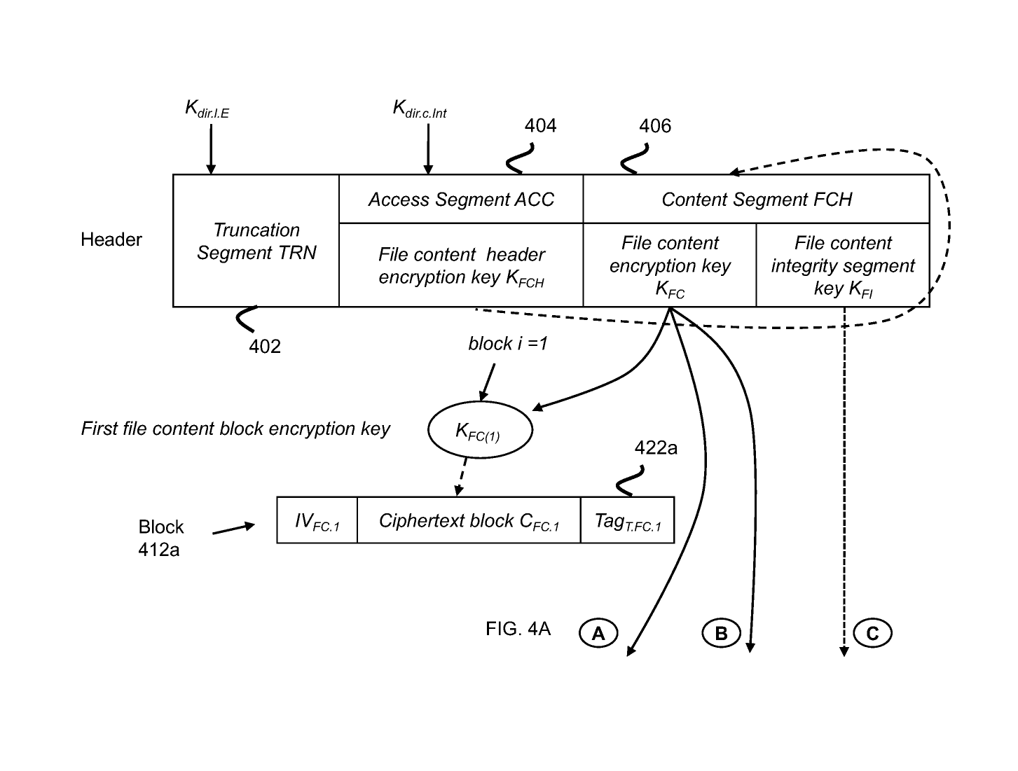

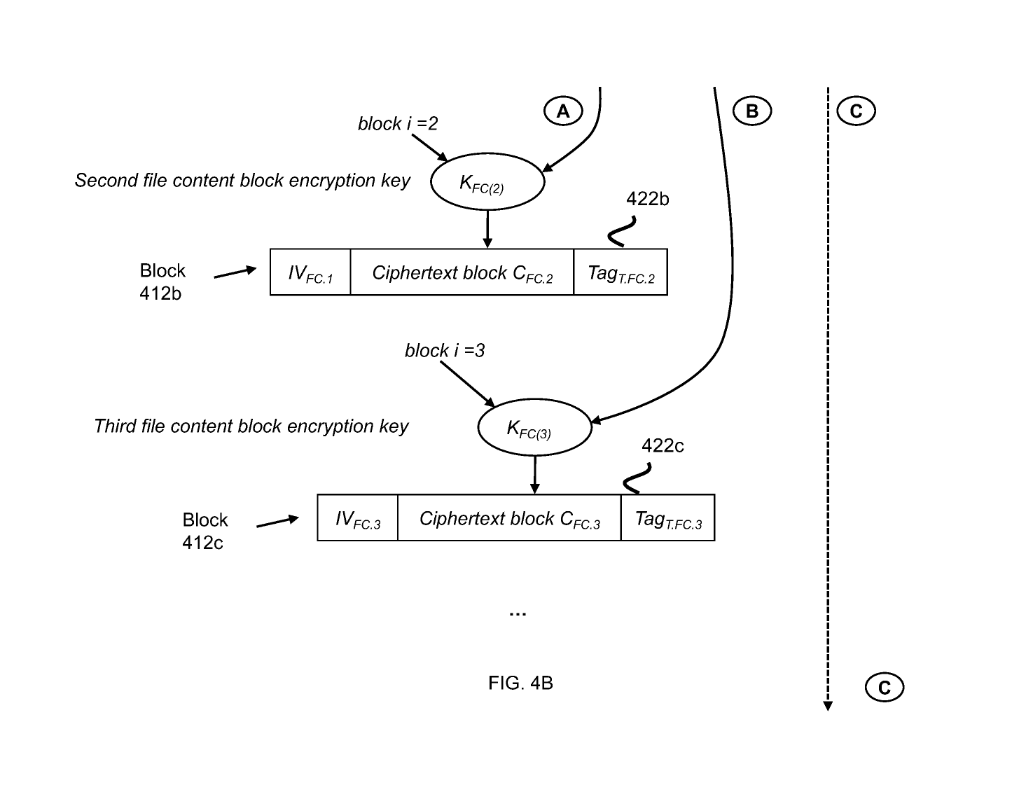

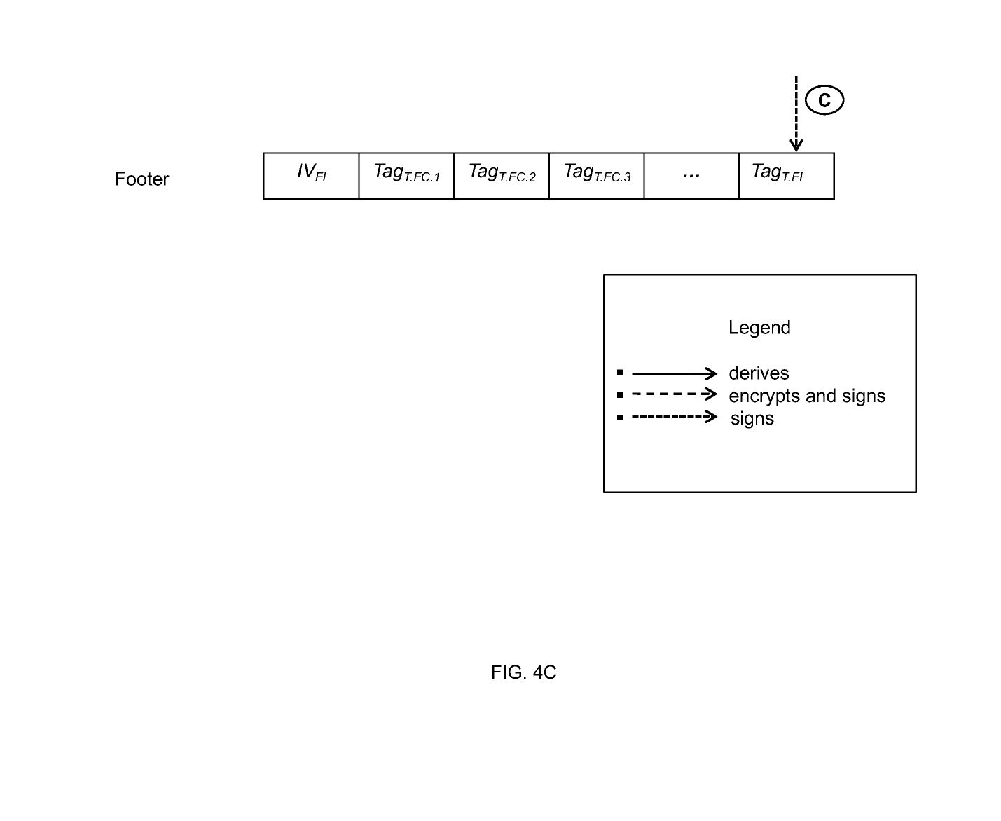

FIGS. 4A-C illustrate an embodiment of the layout of information within an encrypted file. As illustrated, a file header includes a truncation segment 402, an access segment 404, a content segment 406, a file content header encryption key K_{FCH}, a file content encryption key K_{FC}, and a file content integrity segment key K_{FI}.

According to a fourth embodiment, the aspects of the disclosed embodiments facilitate fast random access of the encrypted data including the ability to make changes to the existing files without a need to re-encrypt the entire file. To achieve this objective, the software encryption layer 108 is adapted to split the file content into blocks and encrypt each block separately. In other words, if the user requires to read only a selective part of the file, the user can locate the required part of the file, download it and decrypt it without decrypting other portions of the file since the user can calculate the key used to encrypt those relevant blocks by the key derivation.

Further, the software encryption layer 108 is adapted to calculate a block authentication tag for each block independently and storing the block authentication tag at a predetermined location in the file. An authentication tag may be calculated by a cryptographic function (i.e. a mathematical function) from the file data using a key which may be, for example a subordinate encryption key, wherein both the tag and the data are stored. A subsequent authentication tag may be calculated also using a cryptographic function, which may be the same function, in case the previously calculated authentication tag differs from an original tag. Optionally, any known techniques can be used to calculate the authentication tag.

As illustrated in FIG. 4A-C, each block of the file has its own encryption key. A first block 412a of the file content has a first file content block encryption key K_{FC(1)}, a second block 412b of the file content has a second file content block encryption key K_{FC(2)}, and a third block 412c of the file content has a third file content block encryption key K_{FC(3)}. The first, second and third file content block encryption keys are derived from the file content encryption key K_{FC}.

The first file content block encryption key K_{FC(1)} is used to encrypt the first block 412a of the file content, the second file content block encryption key K_{FC(2)} is used to encrypt the second block 412b of the file content and the third file content block encryption key K_{FC(3)} is used to encrypt the third block 412c of the file content. Further, each block of the file content has its respective block authentication tag namely a tag 422a, a tag 422b and a tag 422c. In addition, the software encryption layer 108 is adapted to calculate an additional authentication tag over all block authentication tags, the file name and the file header authentication tags to ensure integrity of the file content, file name and file creation and modification times.

The splitting of the file content into blocks enables the software encryption layer 108 to address the re-encryption requirements in an efficient manner. When a specific block such as the second block 412b of the file content is modified by the user, the software encryption layer 108 is adapted to re-encrypt only the specific block 412b. The present invention does not require re-encryption of the entire file content. As a result, an amount of input/output operations of the system are substantially reduced and thereby, a processing speed of the system is increased.

Further, access to the file content and blocks of file content is independent of the directory key and the intermediate key. The access at the file level requires an encrypted pathname. In addition, the content of the file can be decrypted using the file content header encryption key K_{FCH} and a specific block of the file can be decrypted using the corresponding file content block encryption key K_{FC(i)}.

The software encryption layer of the aspects of the disclosed embodiments provides seamless and transparent encryption key management to users, applications or application programming interfaces. As a result, privacy and integrity protection in the cloud storage is efficiently achieved.

As already mentioned, the embodiments can be realized in hardware, software, or a combination of hardware and software. A typical combination of hardware and software can be a processing system with an application that, when being loaded and executed, controls the processing system such that it carries out the methods described herein.

The embodiments also can be embedded in an application product, which comprises all the features enabling the implementation of the methods described herein, and which when loaded in a processing system is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (e.g., open language). Accordingly, the above predetermined embodiments may vary within the scope of the attached claims.

1. A method of encrypting files and storing the encrypted files in a storage file system, the method comprising:
configuring a software encryption layer to be located between a caller application and the storage file system;
exposing unencrypted file names and file content by the software encryption layer to the caller application;
encrypting, authenticating and storing by the software encryption layer file names, file modification and creation timestamps, and file contents obtained from the caller application; and
controlling file access by the software encryption layer by allocating different encryption keys to at least one of different groups of files or different portions of file contents, wherein the controlling comprises using a master encryption key to derive subordinate encryption keys, and sharing and distributing the subordinate encryption keys to allow selective access to predetermined subsets of files, or portions of file contents of the storage file system.

2. (canceled)

3. The method according to claim 1, wherein the controlling comprises deriving a dedicated set of encryption keys for each directory of the storage file system.

4. The method according to claim 1, wherein the controlling comprises deriving the different encryption keys for different levels of access.

5. The method according to claim 4, wherein the different levels of access comprise no access, listing path names of a single directory, and listing path names of an entire directory and its children.

6. The method according to claim 4, wherein the different levels of access comprise no access, access to parts of a single file, access to the whole of a single file, access to all files of a single directory, and access to all files of a directory and all its child directories.

7. The method according to claim 1, further comprising performing the encrypting by using a symmetric encryption scheme.

8. The method according to claim 7, further comprising utilizing symmetric encryption algorithms which are resistant to an attack from at least one quantum computing device.

9. The method according to claim 1, wherein the encrypting comprises splitting the file content into blocks and encrypting each block separately, and wherein the controlling comprises calculating a block authentication tag for each block independently and storing the block authentication tag at a predetermined location of the file.

10. The method according to claim 9, wherein the controlling further comprises calculating an additional authentication tag over all block authentication tags, the file name and file header authentication tags, to ensure integrity of the file contents, file name and file creation and modification times.

11. A computer program product comprising code means for execution on a computer system, which when executed by a computer, cause the computer to perform method steps of encrypting files and storing the encrypted files in a storage file system, the method comprising the steps of:
configuring a software encryption layer to be located between a caller application and the storage file system;
exposing unencrypted file names and file content by the software encryption layer to the caller application;
encrypting, authenticating and storing by the software encryption layer file names, file modification and creation timestamps, and file contents obtained from the caller application; and
controlling file access by the software encryption layer by allocating different encryption keys to at least one of different groups of files or different portions of file contents, wherein the controlling comprises using a master encryption key to derive subordinate encryption keys, and sharing and distributing the subordinate encryption keys to allow selective access to predetermined subsets of files, or portions of file contents of the storage file system.

12. A system of encrypting files and storing the encrypted files in a storage file system, the system comprising:
a software encryption layer configured to be located between a caller application and the storage file system;
wherein the software encryption layer is adapted to expose unencrypted file names and file content to the caller application;
wherein the software encryption layer is adapted to encrypt, authenticate and store file names, file modification and creation timestamps, and file contents obtained from the caller application; and
wherein the software encryption layer is adapted to control file access by allocating different encryption keys to at least one of different groups of files or different portions of file contents, wherein the software encryption layer is adapted to control file access by using a master encryption key to derive subordinate encryption keys, and shares and distributes the subordinate encryption keys to allow selective access to predetermined subsets of files, or portions of file contents of the storage file system.

13. The system according to claim 12, wherein the storage file system comprises a cloud system.

14. The system according to claim 12, wherein the software encryption layer is adapted to derive a dedicated set of encryption keys for each directory of the storage file system.

15. The system according to claim 12, wherein the software encryption layer is adapted to derive the different encryption keys for different levels of access.

16. The system according to claim 15, wherein the different levels of access comprise no access, single directory access, and single directory plus child directory access.

17. The system according to claim 15, wherein the different levels of access comprise no access, access to parts of a single file, access to the whole of a single file, access to all files of a single directory, and access to all files of a directory and all its child directories.

18. The system according to claim 12, wherein the software encryption layer is adapted to perform the encrypting by using a symmetric encryption scheme.

19. The system according to claim 18, wherein the software encryption layer is adapted to utilisation of symmetric encryption algorithms that are resistant to an attack from at least one quantum computing device.

20. The system according to claim 12, wherein the encrypting comprises splitting the file content into blocks and encrypting each block separately, and wherein the software encryption layer is adapted to control file access by calculating a block authentication tag for each block independently and storing the block authentication tag at a predetermined location of the file.

21. The system according to claim 20, wherein the software encryption layer is adapted to calculate an additional authentication tag over all block authentication tags, the file name and the file header authentication tags to ensure integrity of the file content, file name and file creation and modification times.
